(19) United States
(12) Patent Application Publication
(10) Pub. No.: US 2004/0175636 A1
(43) Pub. Date: Sep. 9, 2004

(54) Method and device for efficiently generating white light, composed of three unique spectral colors, with the objective of general good-seeing by normal human observer

(76) Inventor: William A. Thornton, Cranford, NJ (US)

Correspondence Address: WILLIAM A. THORNTON, 27 HARVARD ROAD, CRANFORD, NJ, 07016, US

(21) Appl. No.: 10/789,584

(22) Filed: Feb. 27, 2004

Related U.S. Application Data
(60) Provisional application No. 60/451,493, filed on Mar. 4, 2003.

(51) Int. Cl. G03C 3/00

(52) U.S. Cl. 430/10

(57) ABSTRACT

Only recently the shapes and positions of the three spectral sensitivities, of the three input channels to the normal human visual system, have become known with adequate accuracy for commercial exploitation. It is now time, therefore, to design the lighting by which human observers and workers visually operate, so that a maximum of human good-seeing can result from a minimum of kilowatt-hours expended on the lighting. The method is to utilize, in the lighting, only the three spectral colors to which the visual system responds most strongly. The embodiment is a device which efficiently generates white light, using a three-component light-generating medium, the first component electrically energized to exhibit a green emission confined to the immediate wavelength neighborhood of 530 nm, the second an orange-red emission confined to the immediate wavelength neighborhood of 610 nm, and the third a blue-violet emission confined to the immediate wavelength neighborhood of 450 nm.

This application claims benefit of Provisional Patent Application No. 60/451,493, and filing date Mar. 4, 2003. Applicant: William A. Thornton; USA; Cranford, N.J.

### BACKGROUND OF THE INVENTION

The field of endeavor to which this invention pertains is the optimization of the spectral power distribution (SPD) of light entering the visual system of the normal human observer, in the case where it is important that the observer recognize, and most easily grasp the meaning of, information embodied in the entering light. Thus the field of endeavor is the optimization of artificial lights entering a human visual system, either from the picture elements of a television screen display, for example, or from the elements of a specially illuminated scene.

Illumination of mankind's activities is traditionally by means of full-spectrum (broadband) lights, like phases of daylight, firelight, the light of oil lamps, and that of incandescent lamps. The light from each of these sources includes the entire visible spectrum. That is, it contains the full range of visible spectral colors. To explain, FIG. 1 is the spectral composition of noon sunlight in temperate latitudes, and is the representative SPD used by the United States National Air and Space Administration. The range of the visible spectrum is often taken as 400 nm to 700 nm; visual sensitivity is decreasing at both of these endpoints. Normal human vision can distinguish about 150 spectral colors in the visible spectrum. That is, if the visible spectrum of FIG. 1 from 400 nm to 700 nm is sliced into 150 vertical slices, the power content in each two-nanometer slice represents a distinguishable brilliantly colored light of a very narrow range of wavelength. Each slice is called a spectral light, or spectral color, meaning by “spectral” that it is composed of light of essentially a single wavelength. All 150 such lights are present in each of the four types of lights listed above. Their mixture is perceived in each case as white, or whitish, and is an example of familiar illumination. The approximate spectral power distribution (SPD) of the bluish white of the clear sky is shown in FIG. 2 and that of the yellowish white of sunset, in FIG. 3. Each of the lights of FIGS. 1-3 contains all 150 spectral colors, but differs in the ratios of power content of each spectral color relative to that of the others.

Illumination, unless it is natural and abundant, must be visually efficient, or it costs too much to generate and wastes too much of natural resources. Visually efficient illumination is defined, of course, by the normal human visual system itself. It is of great importance to know to which of the 150 distinguishable spectral colors is the normal human visual system most sensitive, and to which of those colored spectral lights is it considerably less sensitive. It is reasonable that visually efficient illumination will be white light that is a mixture of spectral colors to which the visual system is particularly sensitive.

White light can be formed by mixing as few as two of the spectral colors. Blue light plus yellow light, and blue-green light plus red light, are two examples. The rendering of object colors by the resultant whitish light is, however, very poor, and is much improved if, instead of only two spectral colors, three widely-spaced spectral colors are mixed to form the white light.

The visual system “perceives in three dimensions”—not two or four or five. That is, any light resides simultaneously on (1) a scale of brightness running from dim to bright; on (2) another independent scale (hue) running from violet to blue to green to yellow to orange to red to purple; and (3) on a third independent scale running, for example, from white to pale pink to shocking pink to scarlet, a scale called “saturation.” Two lights can differ in only one of these dimensions, or in two or three; hence the independence of the three dimensions of seeing.

Incandescence lamplight, with an SPD like that of FIG. 3, has served well in the last century. However, the more modern SPDs of fluorescent lamplight have much improved the visual efficiency of electrical lamplight. The improvement is based on the following. Mathematicians tell us that the above three independent dimensions-of-seeing indicate the presence of three independent channels operating in the normal human visual system. Each visual channel is represented by a “spectral sensitivity” such as shown schematically in FIG. 4. Here, one visual channel is primarily sensitive to the blue region of the visible spectrum, one channel to the green, and one to the red. The blue channel, for example, is strongly sensitive over a large range of wavelength, say 400 to 500 nm, and similarly for the green and red channels. The writer has been one of the contributors to the continual improvement of fluorescent lamplight for about fifty years. In the early 1960s, working with rare-earth-containing luminescent materials (which are deposited as a paint on the interior surfaces of the bulb walls of a fluorescent lamp), he introduced mixtures of colored emissions to form the SPD of white fluorescent lamplight. How has this innovation so far affected commercial lighting?

The color of sunlight (SPD of FIG. 1, color temperature about 5300K) has turned out to be uncomfortably “cool” for interior lighting. The warmer phase of daylight representing 4000K appears in FIG. 5, and warmer fluorescent lamplight, contrived to match it, appears in FIG. 6. Once the writer's innovation was publicized, commercial lampmakers set about exploiting the promised increase in visual efficiency (usable brightness per lighting watt expended). A typical result of the 1970s was the commercial lamplight of FIG. 7; note the disappearance of the “broadband” concept, typical of natural illuminants (FIGS. 1,2,3,5), in favor of the beginnings of compliance, in FIG. 7, with the preferences of the human visual system—lamplight power content concentrated in the blue, green, and red. Further compliance is apparent in the later lamplight of FIG. 8, which came to be called “prime color lamplight.”

### References Cited

### U.S. Patent Documents

U.S. Pat. No. 3,877,797 October 1973 Thornton

U.S. Pat. No. 4,176,294 December 1976 Thornton

U.S. Pat. No. 4,176,299 January 1978 Thornton

U.S. Pat. No. 4,824,246 November 1987 Thornton

U.S. Pat. No. 4,826,286 May 1988 Thornton

### Other Publications

Thornton, “Luminosity and Color-rendering Capability of White Light,” J. Opt. Soc. Amer.; 1971; pp. 1155-63 cited.

Thornton, “Three-Color Visual Response,” J. Opt. Soc. Amer.; 1972; pp. 457-459 cited.

Thornton, “Matching Lights, Metamers, and Human Visual Response,” J. Color & Appearance; 1973; pp. 23-29 cited.

Thornton, “A System of Photometry and Colorimetry Based Directly on Visual Response,” J. Illum. Engineering Soc.; 1973; pp 99-111 cited.

Thornton, “Reply to Ohta-Wyszecki on Location of Nodes of Metameric Stimuli,” Color Res. & Appl.; 1978; pp. 202-203 cited.

Thornton, “Evidence for the Three Spectral Responses of the Normal Human Visual System,” Color Res. & Appl.; 1986; pp. 160-163 cited.

Thornton, “Note on Visual Responses: System vs. Retinal,” Color Res. & Appl.; pp176-177 cited.

### BRIEF SUMMARY OF THE INVENTION

The present invention confines the power content, of all artificial light which is intended to enter the visual system of any normal human observer, to a mixture of the three spectral colors at those wavelengths marking the peaks of the spectral sensitivities of the normal visual system:

TABLE I

452 nm in the blue-violet,
533 nm in the green, and
611 nm in the orange-red.

The result is that the artificial light so composed is used by the visual system at maximum efficiency; that is, the observer sees the brightest, most colorful scene possible, for unit power content in the light.

### BRIEF DESCRIPTION OF THE DRAWINGS

For a better understanding of the invention, reference may be had to the preferred embodiment, exemplary of the invention shown in the accompanying drawings in which:

FIG. 1 is a graph of the relative power content (watts) per unit wavelength interval versus wavelength, of sunlight at the earth's surface, as used by the National Air and Space Administration;

FIG. 2 is a graph of the relative power content (watts) per unit wavelength interval versus wavelength, of blue-sky light;

FIG. 3 is a graph of the relative power content (watts) per unit wavelength interval versus wavelength, of sunset-yellow-sky light;

FIG. 4 is a graph of spectral sensitivity, of each of the three visual channels of the normal human visual system, in units of cortical signal per watt per unit wavelength interval input to the visual system, versus wavelength.

FIG. 5 is a graph of the relative power content (watts) per unit wavelength interval versus wavelength, of a phase of daylight of 4000K color temperature;

FIG. 6 is a graph of the relative power content (watts) per unit wavelength interval versus wavelength, of white fluorescence lamplight of the same color temperature and color as the preceding daylight phase;

FIG. 7 is a graph of the relative power content (watts) per unit wavelength interval versus wavelength, of white fluorescence lamplight of the same color temperature and color as the lights of FIGS. 5 and 6, but of a modern spectral power distribution (SPD);

FIG. 8 is a graph of the relative power content (watts) per unit wavelength interval versus wavelength, of white fluorescence lamplight of the same color temperature and color as the lights of FIGS. 5 and 6, but of a still more recent spectral power distribution (SPD), known as “prime color” lamplight;

FIG. 9 is a graph of the relative power content (watts) per unit wavelength interval versus wavelength, of white lamplight of the same color temperature and color as average daylight, and formed of a mixture of three line-emissions (such as laser emissions) peaking in the wavelength regions of about 452 nm (blue-violet), 533 nm (green), and 611 nm (orange-red);

FIG. 10 is a graph of the relative power content (watts) per unit wavelength interval versus wavelength, of white lamplight of the same color temperature and color as average daylight, and formed of a mixture of three light-emitting-diode emissions peaking in the wavelength regions of about 452 nm (blue-violet), 533 nm (green), and 611 nm (orange-red);

FIG. 11 is the x, y-chromaticity diagram of the CIE system, showing the chromaticities of six standard reflection colors and their color-rendering by the fluorescent lamplight of FIG. 6 (dotted spectrum upper right, dotted lines) and by the matching lamplight (three-component line-emission, solid spectrum upper right, solid lines);

FIG. 12 is the x, y-chromaticity diagram of the CIE system, showing the chromaticities of the three prime-color primary lights (445 nm, 533 nm, and 612 nm) and the gamut of coloration yielded by them (long dashes). “555” is the peak of the obsolescent luminosity function, not a visual system coordinate. Rectangle: The realm of commercial lamplights;

FIG. 13 is the realm of commercial lamplights, showing the chromaticities and allowable variance in chromaticity of eight commercial lamplights; blue-white at lower left and yellow-white (incandescence) upper right.

### DETAILED DESCRIPTION OF THE INVENTION

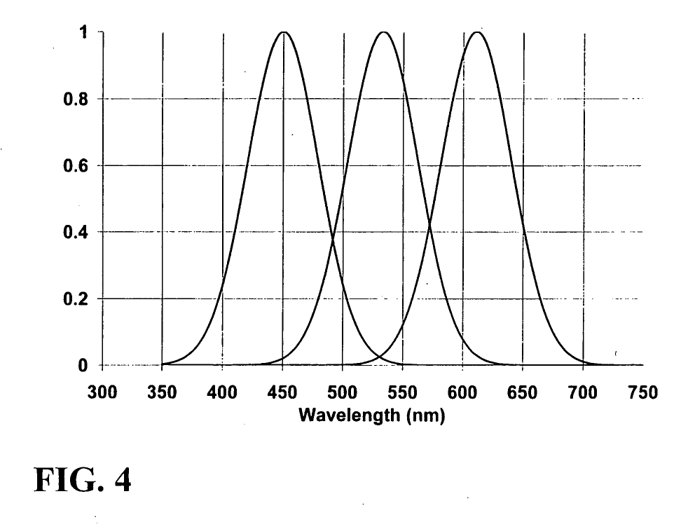

In pursuit of better understanding of the visual system's “perception in three dimensions,” the writer established, through the results of many visual experiments, a close approximation of the actual three spectral sensitivities of the normal human visual system (FIG. 4). The peak wavelengths of these sensitivities are those given in the preceding Table I. These are the spectral colors to which the normal human visual system responds most strongly. It follows that these three spectral colors (spectral lights) are the ones that must be mixed to form white-light illumination of maximum visual efficiency. In fact, these are the spectral colors, one or two or three of which must be present, to the exclusion of all others, in light of any color whatever, if that light must be of maximum visual efficiency.

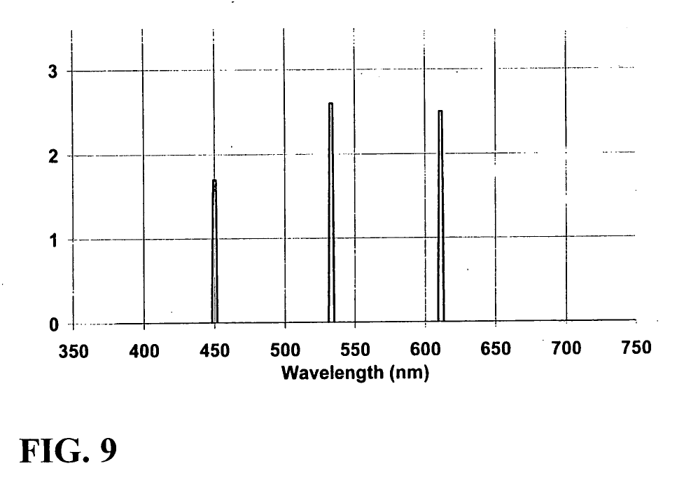

In what form are the required rather-pure spectral colors to be found? Laser emissions may be closest to the ideal, insofar as their power is often concentrated in very narrow ranges of wavelength. Thus the laser power can be input to the visual system rather exactly at one or other of the three peak wavelengths (Table I). FIG. 9 shows, schematically, the SPD of white light consisting of such a mixture of three laser emissions. The lefthand component of laser emission, at 452 nm, is bright blue-violet; the center component, at 533 nm, is bright green; the righthand component, at 611 nm, is bright orange-red; in combination, the three components mix to form bright white light. If the power ratio of the three is adjusted as shown (relative heights of the peaks), the resulting color of the mixture is that of sunlight.

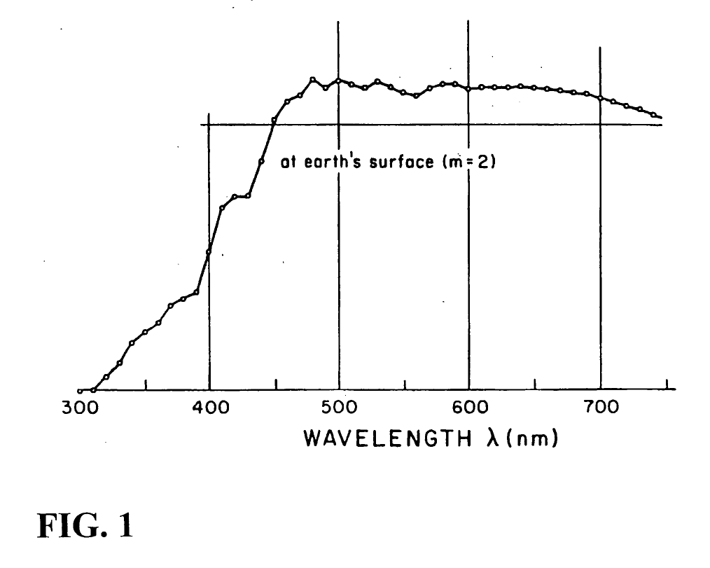

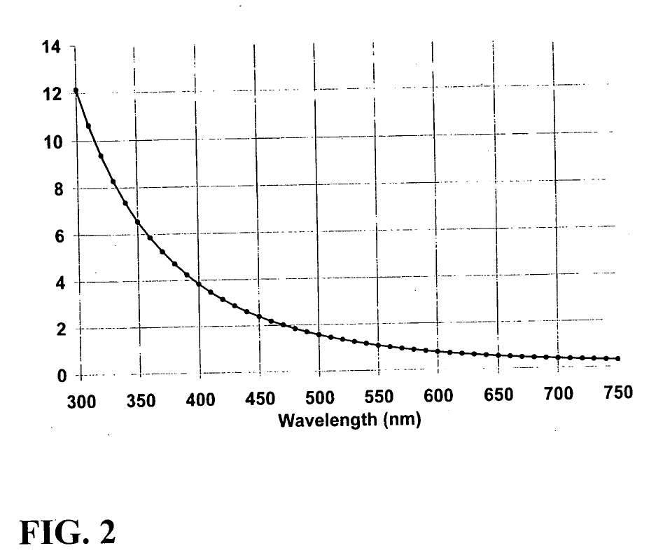

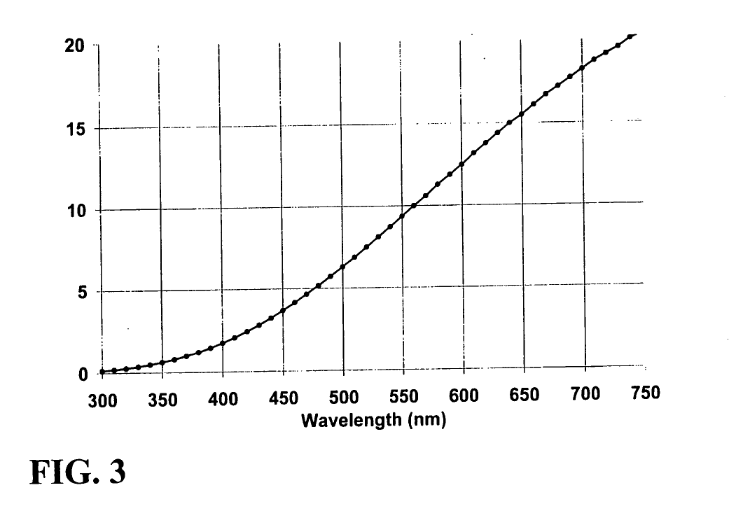

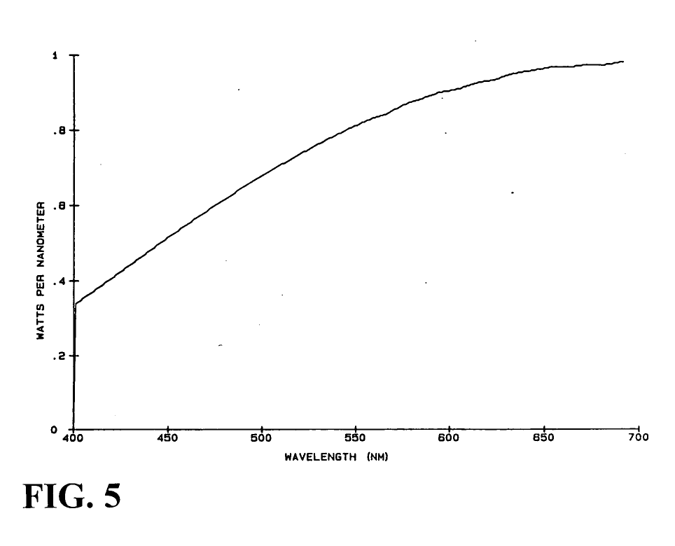

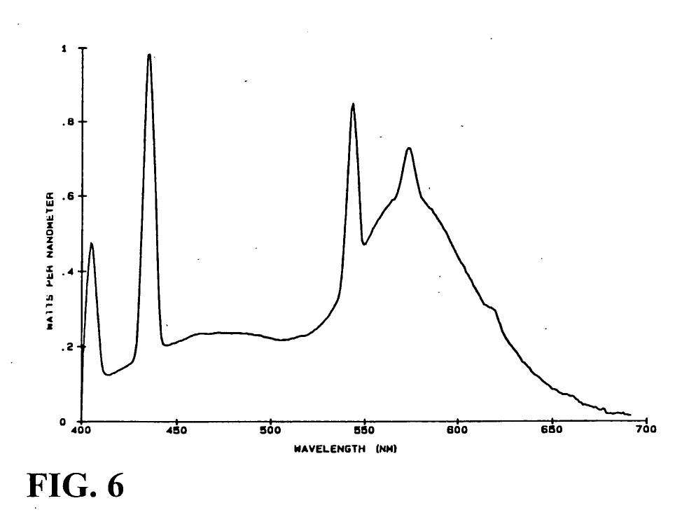

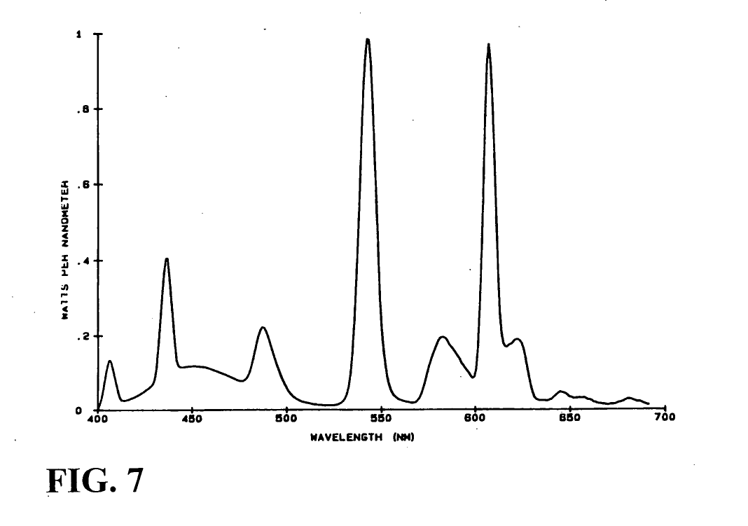

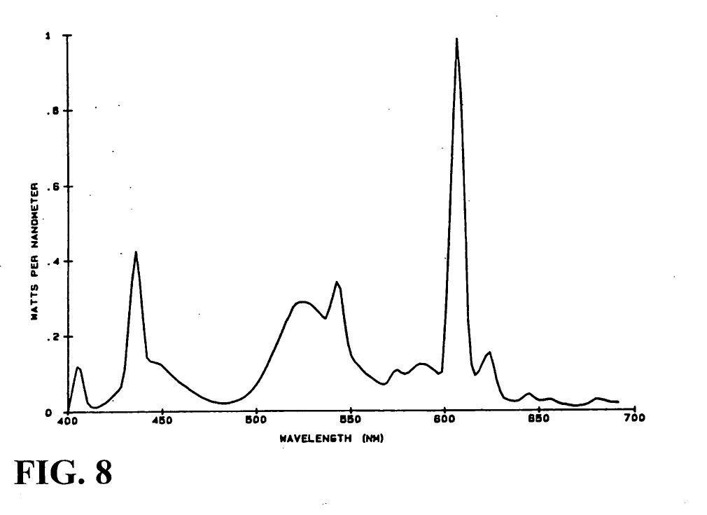

A digression bearing on strong coloration. Commercial lamplight is always white or whitish in color, because the familiar natural illuminations are so. The SPDs of natural and commercial illuminants are strongly varied, as borne out in FIGS. 1-3 and 5-8. In the context of this patent application, however, visual efficiency is of paramount importance. Here, the three spectral colors that mark the wavelengths of maximum visual efficiency of the normal human visual system must be used as the components. There should be no power content at other wavelengths in that white light. Hence the typicality of the SPD of FIG. 9. Still in the case of white light, we note that the power contents of the three light components are (very roughly indeed) of the same magnitude. That suggests, entirely reasonably, that the sensitivities of the three input channels of the normal human visual system are roughly the same in magnitude. This is the point of the digression: To form strongly colored lights, also of maximum visual efficiency, it remains necessary to use only the spectral colors of Table I. But now, at most two of the power contents of the components can be roughly equal. Very strong coloration is expected when one or two are small with respect to the other(s). As examples: Ratio B:G:R=20:20:20 will be whitish light; B:G:R=40:5:40 will be brilliant purple light; B:G:R=100:0:0 will be bright blue-violet light.

As well as being concentrated in wavelength (which is good for visual system efficiency), the laser power is concentrated in space (which can be dangerous to the eye and visual system). However, the beam can be scattered and dispersed in the lighting fixture so as to remove this danger. The limiting factor at present, with laser light sources, is that their electrical efficiency, in converting the electric power into photons output per second, is at present rather low.

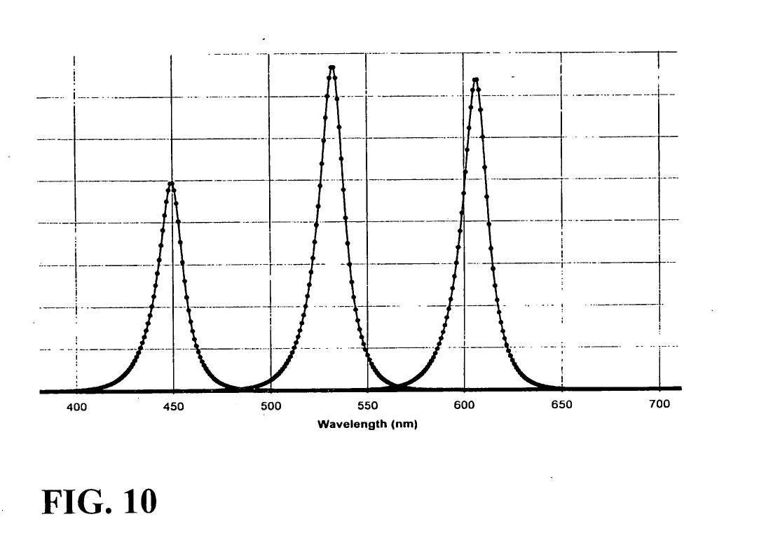

Examples of another light source, light-emitting diodes (LEDs), are by now familiar as small brightly-colored indicators on appliances and equipment of all kinds. As in the case of laser emissions, the light emissions from LEDs are typically restricted to narrow wavelength bands, although not so narrow as that of laser emissions. LEDs are now rapidly becoming (a) diverse in color of emission (hundreds of discrete colors through the visible spectrum), (b) far more visually efficient (high output of photons per second per milliwatt of electric power input), and (c) long-lived as well. FIG. 10 shows an SPD of white light consisting of a mixture of three LED emissions, at the same peak wavelengths and power contents of FIG. 9, and having the same resulting color of the mixture.

The white-light illuminations of FIGS. 1, 9, and 10 may be made visually indistinguishable, providing that perceived brightnesses, as well as colors, are matched. Comparison of those figures implies that much, and even most, of the power content of real sunlight can be removed without changing the color, brightness, or visual appearance of the illumination. This is of course what is required if minimization of input power per unit perceived brightness is to be realized in commercial lighting.

As to color-rendering of the proposed white lights of FIGS. 9 and 10, imagine the following experiment. Set up three slide projectors, each with a narrow-band-pass filter centered at one of the three wavelengths in the above table. The beam emerging from each projector can have an SPD as nearly identical as one wishes to one of the peaks in the SPD of FIG. 9 or FIG. 10. Superimpose the three beams and illuminate an array of real, identifiable objects such as fruit, vegetables, meat, bread, grass, and (most important) include human complexion. The perceived colors of such identifiable objects are of great importance to the typical human observer, and he or she evaluates those rendered colors instantaneously and with great accuracy. Entirely counter to intuition, that array of familiar illuminated objects, although the illumination is now lacking much of its normal spectral content, is seen by the normal observer as colored in a manner more pleasing and satisfying than when illuminated by real sunlight at the same brightness.

Although not completely understood by the writer, the above phenomenon is undoubtedly related to the fact that the remaining constituents in the illumination—the components of FIG. 9 or FIG. 10—are those to which, of all spectral colors, the normal human visual system responds most strongly. Also, power content in the blue-green (near 490 nm) or yellow (near 570 nm), the troughs of FIG. 4, is absent. Power content in those regions may well cause some sort of confusion between (a) the blue visual-system channel and the green channel, or (2) between the green visual-system channel and the orange-red channel.

Reflected lights, from such identifiable objects as those listed above, in real sunlight are full-spectrum, because both the illumination and the spectral reflectances of the objects are full-spectrum. The full-spectrum reflected lights, incoming to the human visual system, are preferentially sampled at the three unique wavelengths, because the three sensitivity curves (FIG. 4) of the visual system in fact peak at those wavelengths. Conversely, the visual system thus consistently ignores, to a degree, the contents of reflected lights that fall outside of spectral regions near 452 nm, 533 nm and 611 nm—namely, spectral regions near 500 nm in the blue-green and near 580 nm in the yellow (to see this, compare FIG. 4 to FIG. 1).

Reflected lights of objects illuminated by the white lights of FIGS. 9 and 10 are already free of these blue-green and yellow components, because those components are not present in the illumination.

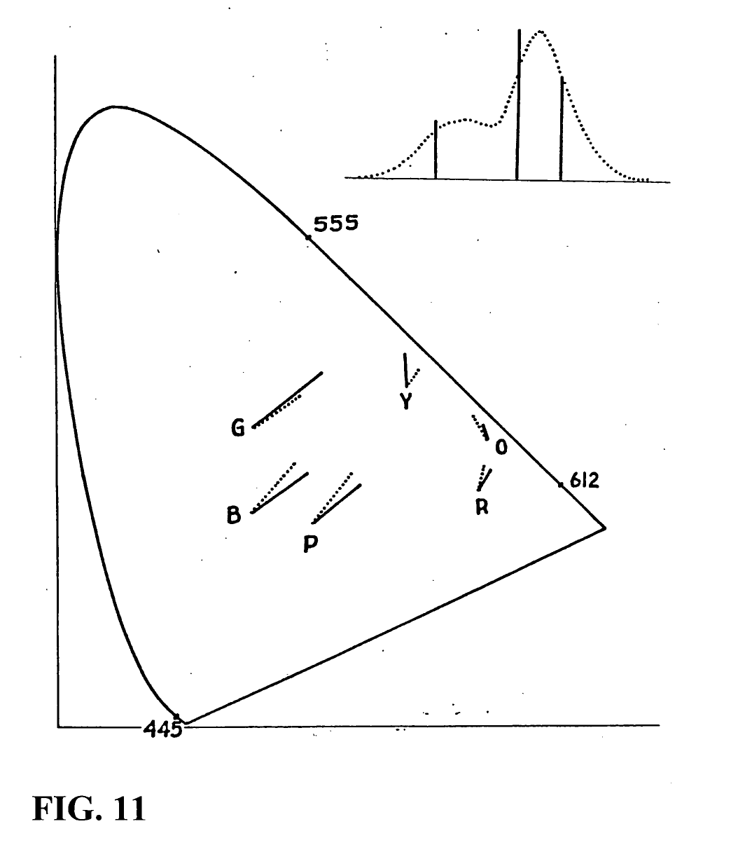

The writer began working with white-light illumination composed of three line-emissions in the 1960s. FIG. 11 was displayed at a Conference chaired by the writer on Nov. 10-11, 1966, attended by sixty engineers and scientists, and dedicated to the improvement of the lamplight provided by fluorescent lamps. The inset at top right of FIG. 11 depicts the SPD of standard fluorescent lamplight (dotted), and the SPD of the alternative three-line illumination (solid). The writer's motivation at that time was to eliminate the deep violet and deep red components of the standard lamplight, because the normal human visual system is poorly responsive to those spectral regions. The writer had not yet discovered the visual sensitivities of FIG. 4, and their implications. The green component in the inset of FIG. 11 lies at 555 nm (the peak of the historical ‘luminosity curve’ upon which we workers of that time relied). Although the writer uncovered the identity of the three prime-color wavelengths (Table I) with some precision in the few years following 1966, he was not yet aware in 1966 that visual response in the green region peaks at about 533 nm, far enough from 555 nm to make the latter a poor choice there. Nevertheless, he as able to show the Conference attendees that color rendering by the three line emissions chosen then (445 nm, 555 nm, and 612 nm) comprised a white illumination that rendered colors quite similarly to the normal fluorescent lamplight (dotted). Color-rendering of six colored objects, by the two lamplights, is compared in the chromaticity diagram of FIG. 11.

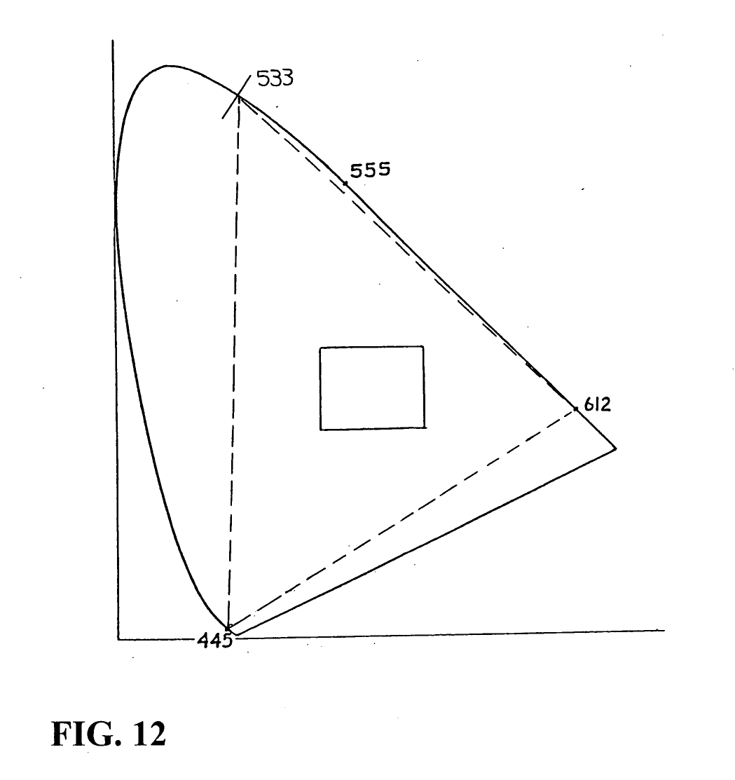

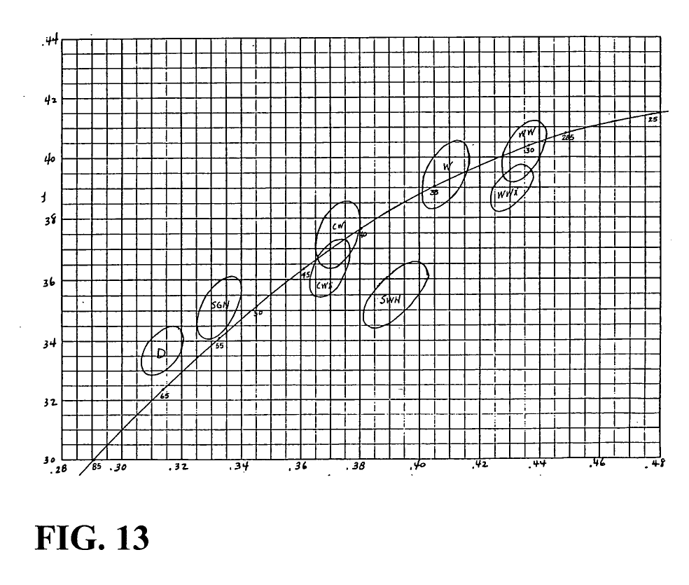

The wavelengths of actual peak visual-system responses are indicated in Table I. The associated spectral colors (452 nm, 533 nm, and 611 nm, approximately) act rather like the “primaries” of the normal human visual system, and they relate to the gamut of colors that the normal human is able to see. Although this complex element of vision will not be covered properly here, I wish to use the chromaticity diagram of FIG. 12 to suggest the proper gamut of coloration by the dashed triangle, and to show how far the old value of 555 nm of peak “luminosity” lies from the correct wavelength of peak green sensitivity. Also shown in the rectangle within FIG. 12 is the chromaticity realm of commercial lamplights. This rectangle is magnified in FIG. 13, which plots illumination colors of eight commercial lamplights, from “daylight” at lower left to “warm white” at upper right. Lamplights with SPDs of interest in this patent (FIGS. 9 and 10) can be adjusted—for example to any of the lamplight colors in FIG. 13—simply by adjusting the triple ratio of peak heights (power contents) to suit.

In summary, the proposed illumination with the SPD of FIG. 9 or of FIG. 10 delivers a given brightness to illuminated scenes with the use of far smaller power content than, for example, real sunlight or incandescent lamplight delivering the same brightness. Of equally important advantage is that coloration under the proposed illumination is more pleasant and satisfying.

I claim:

1. A device which efficiently generates white light and illuminates objects with a color appearance which is reasonably representative of their color appearance under natural light, said device comprising:
(a) a three-component, light-generating medium forming an operative part of said device;
(b) means for connecting said device to a source of predetermined electric potential to energize said medium to a visible-light-generating condition;
(c) a first component of said medium when energized exhibiting a green laser emission located substantially in the wavelength range of from 515 nm to 540 nm;
(d) a second component of said medium when energized exhibiting an orange-red laser emission located substantially in the wavelength range of from 600 nm to 625 nm;
(e) the third component of said medium when energized exhibiting a blue-violet laser emission located substantially in the wavelength range of from 440 nm to 465 nm; and
(f) the relative proportions of said components of said light-producing medium being such that when their emissions are blended, there is produced white light of predetermined ICI coordinates.

2. The device as specified in claim 1 wherein,
(a) said first component of said medium when energized exhibiting at least one of (1) a single laser emission within the wavelength range of from 515 nm to 540 nm, and (2) a group of laser emissions the principal members of which fall within the wavelength range of from 515 nm to 540 nm;
(b) said second component of said medium when energized exhibiting at least one of (1) a single laser emission within the wavelength range of from 600 nm to 625 nm, and (2) a group of laser emissions the principal members of which fall within the wavelength range of from 600 nm to 625 nm;
(c) said other remaining component of said medium when energized exhibiting at least one of (1) a single laser emission within the wavelength range of 440 nm to 465 nm, and (2) a group of laser emissions the principal members of which fall within the wavelength range of from 440 nm to 465 nm.

3. A device which efficiently generates white light and illuminates objects with a color appearance which is reasonably representative of their color appearance under natural light, said device comprising:
(a) a three-component, light-generating medium forming an operative part of said device;
(b) means for connecting said device to a source of predetermined electric potential to energize said medium to a visible-light-generating condition;
(c) a first component of said medium when energized exhibiting a green laser emission located substantially in the wavelength range of from 515 nm to 540 nm;
(d) a second component of said medium when energized exhibiting an orange-red laser emission located substantially in the wavelength range of from 600 nm to 625 nm;
(e) the third component of said medium when energized enhibiting a blue-violet laser emission located substantially in the wavelength range of from 440 nm to 465 nm; and
(f) the relative proportions of said components of said light-producing medium being such that when their emissions are blended, there is produced white light of predetermined ICI coordinates with at most only a limited amount of radiations of wavelengths shorter than 430 nm and longer than 630 nm as well as at most only a limited amount of radiations of about 500 nm and about 575 nm.

4. The device as specified in claim 3 wherein
(a) said first component of said medium when energized exhibiting at least one of (1) a single laser emission within the wavelength range of from 515 nm to 540 nm, and (2) a group of laser emissions the principal members of which fall within the wavelength range of from 515 nm to 540 nm;
(b) said second component of said medium when energized exhibiting at least one of (1) a single laser emission within the wavelength range of from 600 nm to 625 nm, and (2) a group of laser emissions the principal members of which fall within the wavelength range of from 600 nm to 625 nm;
(c) said other remaining component of said medium when energized exhibiting at least one of (1) a single laser emission within the wavelength range of 440 nm to 465 nm, and (2) a group of laser emissions the principal members of which fall within the wavelength range of from 440 nm to 465 nm.

5. A device which efficiently generates white light and illuminates objects with a color appearance which is reasonably representative of their color appearance under natural light, said device comprising:
(a) a three-component, light-generating medium forming an operative part of said device;
(b) means for connecting said device to a source of predetermined electric potential to energize said medium to a visible-light-generating condition;
(c) a first component of said medium when energized exhibiting a green laser emission located substantially in the wavelength range of from 515 nm to 540 nm;
(d) a second component of said medium when energized exhibiting an orange-red laser emission located substantially in the wavelength range of from 600 nm to 625 nm;
(e) the third component of said medium when energized enhibiting a blue-violet laser emission located substantially in the wavelength range of from 440 run to 465 nm; and (f) the relative proportions of said components of said light-producing medium being such that when their emissions are blended, there is produced white light of predetermined ICI coordinates with minimized radiations in the wavelength ranges of from 465 nm to 515 nm and from 540 nm to 600 nm and with at most only a limited amount of radiations of wavelengths shorter than 430 nm and longer than 630 nm as well as at most only a limited amount of radiations of wavelengths of about 500 nm and about 575 nm.

6. The device as specified in claim 5 wherein,
(a) said first component of said medium when energized exhibiting at least one of (1) a single laser emission within the wavelength range of from 515 nm to 540 nm, and (2) a group of laser emissions the principal members of which fall within the wavelength range of from 515 nm to 540 run;
(b) said second component of said medium when energized exhibiting at least one of (1) a single laser emission within the wavelength range of from 600 nm to 625 nm, and (2) a group of laser emissions the principal members of which fall within the wavelength range of from 600 nm to 625 nm;
(c) said other remaining component of said medium when energized exhibiting at least one of (1) a single laser emission within the wavelength range of 440 nm to 465 nm, and (2) a group of laser emissions the principal members of which fall within the wavelength range of from 440 nm to 465 nm with minimized radiations in the wavelength ranges of from 465 nm to 515 nm and from 540 nm to 600 nm and with at most only a limited amount of radiations of wavelengths shorter than 430 nm and longer than 630 nm as well as at most only a limited amount of radiations of wavelengths of about 500 nm and about 575 nm.

7. A device which efficiently generates white light and illuminates objects with a color appearance which is reasonably representative of their color appearance under natural light, said device comprising:
(a) a three-component, light-generating medium forming an operative part of said device;
(b) means for connecting said device to a source of predetermined electric potential to energize said medium to a visible-light-generating condition;
(c) a first component of said medium when energized exhibiting a green light-emitting-diode emission located substantially in the wavelength range of from 515 nm to 540 nm;
(d) a second component of said medium when energized exhibiting an orange-red light-emitting-diode emission located substantially in the wavelength range of from 600 nm to 625 nm;
(e) the third component of said medium when energized enhibiting a blue-violet light-emitting-diode emission located substantially in the wavelength range of from 440 nm to 465 nm; and
(f) the relative proportions of said components of said light-producing medium being such that when their emissions are blended, there is produced white light of predetermined ICI coordinates.

8. The device as specified in claim 7 wherein,
(a) said first component of said medium when energized exhibiting at least one of (1) a single light-emitting-diode emission within the wavelength range of from 515 nm to 540 nm, and (2) a group of light-emitting-diode emissions the principal members of which fall within the wavelength range of from 515 nm to 540 nm;
(b) said second component of said medium when energized exhibiting at least one of (1) a single light-emitting-diode emission within the wavelength range of from 600 nm to 625 nm, and (2) a group of light-emitting-diode emissions the principal members of which fall within the wavelength range of from 600 nm to 625 nm;
(c) said other remaining component of said medium when energized exhibiting at least one of (1) a single light-emitting-diode emission within the wavelength range of 440 nm to 465 nm, and (2) a group of light-emitting-diode emissions the principal members of which fall within the wavelength range of from 440 nm to 465 nm.

9. A device which efficiently generates white light and illuminates objects with a color appearance which is reasonably representative of their color appearance under natural light, said device comprising:
(a) a three-component, light-generating medium forming an operative part of said device;
(b) means for connecting said device to a source of predetermined electric potential to energize said medium to a visible-light-generating condition;
(c) a first component of said medium when energized exhibiting a green Light-emitting-diode emission located substantially in the wavelength range of from 515 nm to 540 nm;
(d) a second component of said medium when energized exhibiting an orange-red Light-emitting-diode emission located substantially in the wavelength range of from 600 nm to 625 nm;
(e) the third component of said medium when energized enhibiting a blue-violet light-emitting-diode emission located substantially in the wavelength range of from 440 nm to 465 nm; and
(f) the relative proportions of said components of said light-producing medium being such that when their emissions are blended, there is produced white light of predetermined ICI coordinates with at most only a limited amount of radiations of wavelengths shorter than 430 nm and longer than 630 nm as well as at most only a limited amount of radiations of about 500 nm and about 575 nm.

10. The device as specified in claim 9 wherein
(a) said first component of said medium when energized exhibiting at least one of (1) a single light-emitting-diode emission within the wavelength range of from 515 nm to 540 nm, and (2) a group of light-emitting-diode emissions the principal members of which fall within the wavelength range of from 515 nm to 540 nm;
(b) said second component of said medium when energized exhibiting at least one of (1) a single light-emitting-diode emission within the wavelength range of from 600 nm to 625 nm, and (2) a group of light-emitting-diode emissions the principal members of which fall within the wavelength range of from 600 nm to 625 nm;
(c) said other remaining component of said medium when energized exhibiting at least one of (1) a single light-emitting-diode emission within the wavelength range of 440 nm to 465 nm, and (2) a group of light-emitting-diode emissions the principal members of which fall within the wavelength range of from 440 nm to 465 nm.

11. A device which efficiently generates white light and illuminates objects with a color appearance which is reasonably representative of their color appearance under natural light, said device comprising:
(a) a three-component, light-generating medium forming an operative part of said device;
(b) means for connecting said device to a source of predetermined electric potential to energize said medium to a visible-light-generating condition;
(c) a first component of said medium when energized exhibiting a green light-emitting-diode emission located substantially in the wavelength range of from 515 nm to 540 nm;
(d) a second component of said medium when energized exhibiting an orange-red light-emitting-diode emission located substantially in the wavelength range of from 600 nm to 625 nm;
(e) the third component of said medium when energized enhibiting a blue-violet light-emitting-diode emission located substantially in the wavelength range of from 440 nm to 465 nm; and
(f) the relative proportions of said components of said light-producing medium being such that when their emissions are blended, there is produced white light of predetermined ICI coordinates with minimized radiations in the wavelength ranges of from 465 nm to 515 nm and from 540 nm to 600 nm and with at most only a limited amount of radiations of wavelengths shorter than 430 nm and longer than 630 nm as well as at most only a limited amount of radiations of wavelengths of about 500 nm and about 575 nm.

12. The device as specified in claim 11 wherein,
(a) said first component of said medium when energized exhibiting at least one of (1) a single light-emitting-diode emission within the wavelength range of from 515 nm to 540 nm, and (2) a group of light-emitting-diode emissions the principal members of which fall within the wavelength range of from 515 nm to 540 nm;
(b) said second component of said medium when energized exhibiting at least one of (1) a single light-emitting-diode emission within the wavelength range of from 600 nm to 625 nm, and (2) a group of light-emitting-diode emissions the principal members of which fall within the wavelength range of from 600 nm to 625 nm;
(c) said other remaining component of said medium when energized exhibiting at least one of (1) a single light-emitting-diode emission within the wavelength range of 440 nm to 465 nm, and (2) a group of light-emitting-diode emissions the principal members of which fall within the wavelength range of from 440 nm to 465 nm with minimized radiations in the wavelength ranges of from 465 nm to 515 nm and from 540 nm to 600 nm and with at most only a limited amount of radiations of wavelengths shorter than 430 nm and longer than 630 nm as well as at most only a limited amount of radiations of wavelengths of about 500 nm and about 575 nm.
